(19) United States
(12) Patent Application Publication
(10) Pub. No.: US 2026/0216803 A1
(43) Pub. Date: Jul. 30, 2026

(54) METHOD FOR GEAR MACHINING AT LEAST ONE WORKPIECE

(71) Applicant: Liebherr-Verzahntechnik GmbH, Kempten (DE)

(72) Inventors: Hansjoerg Geiser, Kempten (DE); Steffen HAUN, Kempten (DE)

(21) Appl. No.: 19/459,630

(22) Filed: Jan. 26, 2026

(30) Foreign Application Priority Data
Jan. 29, 2025 (DE) 10 2025 103 190.8

(51) Int. Cl. B23F 1/06

(52) U.S. Cl. CPC B23F 1/06

(57) ABSTRACT

The present disclosure shows a method for gear machining of one or more workpieces by means of a toothed fine machining tool with geometrically cutting edge, which has a barrel-shaped basic form, wherein the fine machining tool and the workpiece rotate rollingly coupled with one another while the fine machining tool, in at least one toothing cut, is moved in a feed direction parallel to the axis of rotation of the workpiece in order to machine the workpiece over the workpiece width. Between the machining of two workpieces and/or two toothing cuts on one workpiece and/or during a toothing cut, the contact line between fine machining tool and workpiece is deliberately shifted on the fine machining tool in order to bring another region of the tool surface into use, by changing the tilt angle between the fine machining tool and the workpiece.

### CROSS REFERENCE TO RELATED APPLICATION

The present application claims priority to German Patent Application No. 10 2025 103 190.8 filed on January 29, 2025. The entire contents of the above-listed application are hereby incorporated by reference for all purposes.

### TECHNICAL FIELD

The present disclosure relates to a method for gear machining, for example for hard fine machining, of at least one workpiece by means of a fine machining tool with undefined cutting edge, which has a barrel-shaped basic form, and to a corresponding gear cutting machine. In particular, the workpiece may be an internally toothed workpiece.

### BACKGROUND

For the hard fine machining of internal toothings there are various continuous generating finishing methods. These are in particular:

honing with corundum tools

generating grinding with corundum grinding worms

honing with dress-free CBN tools

generating grinding with dress-free CBN grinding worms

hard skiving with gear skiving wheels (geometrically defined cutting edge)

### SUMMARY

The challenge is to be able to machine as many workpieces as possible with one tool. In this case, the quality is to be kept within the required limits.

The methods with corundum tools (generating grinding, honing) allow, by dressing, a re-sharpening of the tool, whereby after a machining cycle the workpiece quality can be brought back into the desired quality up to the wear limit. However, dressing is time-consuming.

In the method of hard skiving, corresponding feed marks arise in the flanks on account of the few cutting edges, which can have a negative effect on load-carrying capacity or noise behavior.

With a CBN-coated tool, it is possible, as with corundum tools, to move radially into the toothing (similar to the kinematics in honing) or to move axially through the toothing (generating grinding). The time expenditure for dressing is omitted. However, higher tool costs arise.

From generating grinding of externally toothed workpieces it is known, between two toothing cuts and/or during a toothing cut, to move the tool in the direction of its axis of rotation in order to bring another region of the tool surface into use. In this way, the surface of the tool can be better utilized. This is also referred to as shifting or shift strategy. For the gear machining of internal toothings by means of a CBN-coated fine machining tool which has a barrel-shaped basic form, there is, however, to date no comparable solution. In particular, the tool cannot be moved in the direction of its axis of rotation on account of its barrel shape.

Document US 8,382,560 B2 discloses such a fine machining tool which has a barrel-shaped basic form and is used for continuous generating grinding.

Various documents already show gear machining methods of a gear with internal toothing by a fine machining tool which has a barrel-shaped basic form, wherein the fine machining tool and the workpiece rotate rollingly coupled with one another while the fine machining tool, in at least one toothing cut, is moved in a feed direction parallel to the axis of rotation of the workpiece through the workpiece in order to machine the workpiece over the workpiece width.

In this case, machining is in each case carried out with a fixed contact path between fine machining tool and workpiece and with an axis crossing angle which is predetermined by the geometry of the fine machining tool and of the workpiece and with a tilt angle of zero between workpiece and fine machining tool.

Thus, in document EP 2383064 B1, the axis crossing angle is set to a fixed value as a function of the amount of crowning of the fine machining tool. In document EP 2 460 625 B1, the axis crossing angle is in each case adapted, after dressing, to the new diameter of the tool. Document EP 2 471 621 B1 provides for setting the axis crossing angle as a function of the helix angles of the toothings of workpiece and tool. In this case, a correction of errors in the actual position of the tool is to be carried out as a function of measured profile errors on the workpiece.

Document EP 3274120 B1 shows a method for gear machining of internally toothed workpieces in which a combined tool is used which has a tool for hard skiving and a tool for honing, which are used in succession for gear machining.

Irrespective of whether machining is carried out with dressable tools such as, for example, corundum tools or dress-free tools such as CBN tools, the wear of the tool is a decisive factor for the cost-effectiveness of the method.

It is therefore the object of the present disclosure to provide an improved method for gear machining of at least one workpiece by means of a fine machining tool which has a barrel-shaped basic form.

This object is achieved by a method as described herein.

In the following, we use, for describing the present disclosure, established designations from gear skiving, as they are described, for example, in EP 2520390 B2. In particular, we use the terms “axis crossing angle”, “effective axis crossing angle”, “common perpendicular” and “tilt angle” in the meaning customary for gear skiving, as described there.

The present disclosure comprises a method for gear machining of one or more workpieces by means of a toothed fine machining tool with undefined cutting edge, which has a barrel-shaped basic form, wherein the fine machining tool and the workpiece rotate rollingly coupled with one another while the fine machining tool, in at least one toothing cut, in engagement with the workpiece, is moved in a feed direction parallel to the axis of rotation of the workpiece along the workpiece width in order to machine the workpiece over the workpiece width. In this case, it is provided that, between the machining of two workpieces and/or between two toothing cuts on one workpiece and/or during a toothing cut, the contact path between fine machining tool and workpiece is deliberately shifted on the fine machining tool in order to bring another region of the tool surface into use, by changing the tilt angle between the fine machining tool and the workpiece.

The inventor of the present disclosure has recognized that, by changing the tilt angle, it is possible, in the case of a barrel-shaped fine machining tool with undefined cutting edge, to shift the contact path between fine machining tool and workpiece on the fine machining tool without this leading to changes in the geometry of the workpiece machined with the fine machining tool. In this way, it is possible to use another region of the tool surface for fine machining and thus to better utilize the tool surface. In particular, by changing the tilt angle, the contact path can be shifted into another region of the tool surface in which the tool surface has not yet been worn, or has been worn to a lesser extent, than in the region in which the contact path ran before shifting.

The contact path is in this case that path on the tool which generates the final geometry which is present after the respective cut.

In particular, shift strategies which are used in gear machining of external toothings or with cylindrical tools by shifting the tool in the direction of the tool axis can now also be used in gear machining of internal toothings or with barrel-shaped tools, by correspondingly changing the tilt angle.

According to a possible embodiment of the present disclosure, the workpiece may be an internally toothed workpiece. However, the present disclosure can also be used when the workpiece is an externally toothed workpiece.

The method according to the disclosure for gear machining can be used for example for the hard fine machining of the workpiece.

According to a possible embodiment of the present disclosure, the machining can be carried out within the scope of the present disclosure with the kinematics of gear skiving machining. It is therefore optionally a gear skiving method with undefined cutting edge.

According to a possible embodiment of the present disclosure, the relative movement of workpiece and fine machining tool therefore takes place with the kinematics of gear skiving machining.

According to a possible embodiment of the present disclosure, the fine machining tool is a gear skiving tool with undefined cutting edge. For example, a fine machining tool is used here as described in more detail below.

According to a possible embodiment of the present disclosure, the method according to the disclosure can be a machining method with theoretical point contact.

The axis crossing angles used within the scope of the method according to the disclosure can lie, for example, in a range between 0 degrees and ± the helix angle of the workpiece and/or in a range between 0 degrees and ± 30°, optionally in a range between 0 degrees and ± 25°.

The helix angle of the tool can lie, for example, in a range between 0 degrees and ± the helix angle of the workpiece and/or in a range between 0 degrees and ± 30°, optionally in a range between 0 degrees and ± 25°.

According to a possible embodiment of the present disclosure, the fine machining tool may be a non-dressable tool, for example an optionally galvanically coated CBN tool, or the contact path between fine machining tool and workpiece on the fine machining tool is shifted without dressing the fine machining tool in the meantime. In both cases, the tilt angle is therefore not changed in order to adapt it to the geometry of the tool, but in order to better utilize the available surface of the tool, which is either non-dressable or is made available by dressing.

According to a possible embodiment of the present disclosure, the contact path between fine machining tool and workpiece on the fine machining tool is shifted after a predetermined number of toothing cuts and/or a predetermined shift strategy.

According to a possible embodiment of the present disclosure, the change of the tilt angle takes place without or independently of a measurement of an actually produced geometry of the workpiece. The tilt angle should therefore not be corrected in order to eliminate profile errors; rather, the tilt angle is changed in order to shift the contact path to another position and thus to better utilize the tool surface.

According to a possible embodiment of the present disclosure, after shifting of the contact path, the same geometry of the workpiece is produced as before shifting of the contact path. Shifting of the contact path is therefore not used to correct errors in the geometry of the workpiece, but to better utilize the tool surface.

According to a possible embodiment of the present disclosure, one or more further movement axes of the gear cutting machine are moved together with the change of the tilt angle such that, despite the shifting of the contact path, the same geometry is produced on the workpiece as before shifting of the contact path.

For example, in this case the one or more further movement axes of the gear cutting machine are moved as a function of the amount of the change of the tilt angle.

Optionally, in the case of a change of the tilt angle, the axis crossing angle and/or the center distance is tracked.

According to a possible embodiment of the present disclosure, the contact path between fine machining tool and workpiece on the fine machining tool is deliberately shifted in order to bring another region of the tool surface into use by changing the relative position between the fine machining tool and the workpiece by changing the center distance, tilt angle and axis crossing angle. In particular, in this case the tilt angle is deliberately changed and the center distance and the axis crossing angle are adapted to the new tilt angle.

According to a possible embodiment of the present disclosure, the contact path is shifted several times into another region of the tool surface by a change of the tilt angle, the shifting optionally in each case taking place such that the tool surface in the other region has not yet been worn, or has been worn to a lesser extent, than in the region in which the contact path ran before shifting. Between the changes of the tilt angle, gear machining is in each case carried out by which the tool surface in the region of the contact path is subjected to wear.

According to a possible embodiment of the present disclosure, the contact path is shifted in one or more steps by a total of at least 10% of the tool width, optionally by a total of at least 20% of the tool width.

According to a possible embodiment of the present disclosure, the tilt angle is changed in one or more steps by a total of at least 1 degree, optionally by a total of at least 2 degrees and optionally by at least 4 degrees.

According to a possible embodiment of the present disclosure, material removal on the workpiece in one machining cut takes place within a contact region with the fine machining tool which, on the fine machining tool, has an extent in the feed direction, wherein the contact path is formed by the end of the contact region which lies at the rear in the feed direction. The contact path therefore defines the geometry resulting on the workpiece through the fine machining process, whereas material removal takes place in a contact region enlarged relative to the contact path.

According to a possible embodiment of the present disclosure, the barrel shape of the fine machining tool and/or the form of the teeth and the infeed to the workpiece are selected such that the width of a contact region between the workpiece and the fine machining tool, in which material removal on the workpiece takes place in one machining cut, amounts to at least 10% of the tool width, optionally at least 20% of the tool width.

According to a possible embodiment of the present disclosure, if a finishing cut is carried out as the next machining cut, the contact path is shifted in the direction of the feed direction in order to bring into use a region of the tool surface which has hitherto not yet been used for fine machining.

According to a possible embodiment of the present disclosure, the fine machining tool is clamped on a tool arbor which is mounted at one end in a tool holder.

Optionally, the feed movement of the machining cut is carried out in a pulling manner. In this way, collisions of the fine machining tool and/or the tool arbor with the workpiece are avoided.

According to a possible embodiment of the present disclosure, the fine machining tool has two width regions with different abrasive material, for example with different coating. For example, the first width region has a first grain size and the second width region has a second grain size, the grain sizes being different from one another and in particular one grain size being coarser than the other grain size.

The two regions can thus be used, for example, for different machining steps, for example a rough machining (roughing) and a fine machining (finishing). Furthermore, the division of the tool can take account of the fact that material removal takes place over an extended contact surface in which therefore, at least in part, coarser abrasive material is optionally used, whereas the geometry produced is determined solely by the contact line which therefore optionally runs in a width region with finer abrasive material.

According to a possible embodiment of the present disclosure, by tilting the fine machining tool between a roughing machining and a finishing machining a first width region is used for roughing and a second width region is used for finishing.

According to a possible embodiment of the present disclosure, the contact region during fine machining is selected such that a front part of the contact region in the feed direction lies in a first width region with a first grain size and the contact path lies in a second width region with a second grain size, the first grain size being coarser than the second grain size.

According to a possible embodiment of the present disclosure, a point of the fine machining tool having the largest radius is arranged offset with respect to the middle of the tool width and divides the tool into a first and a second region with decreasing radius starting from this point, which have different widths. This makes it possible to keep the tilt angles in a range which is favorable with regard to collisions.

Optionally, the difference in the width of the two regions amounts to at least 5% of the smaller value in terms of absolute value, optionally at least 10%.

Alternatively or additionally, the first region which is arranged at the front in the feed direction and/or is remote from the tool holder can have a greater width than the second region which is arranged at the rear in the feed direction and/or is directed towards the tool holder.

According to a possible embodiment of the present disclosure, when machining a workpiece with a first contact region which lies adjacent to an end of the fine machining tool lying at the front in the feed direction and/or remote from the tool holder, machining is carried out with a tilt angle of greater absolute value than when machining a workpiece with a second contact region which lies adjacent to an end of the fine machining tool lying at the rear in the feed direction and/or directed towards the tool holder.

In the first variant, this takes account of the fact that the contact path is arranged on the side of the contact region lying at the rear in the feed direction and therefore, in the case of a first contact region which lies adjacent to an end of the fine machining tool lying at the front in the feed direction, is spaced from the end of the fine machining tool lying at the front in the feed direction by the width of the contact region, so that machining with a smaller tilt angle is possible here. In the case of the second contact region which lies adjacent to an end of the fine machining tool lying at the rear in the feed direction, the contact path, by contrast, lies directly adjacent to the rear end of the fine machining tool, so that a greater tilt angle is required. This consideration or procedure applies in particular when the barrel shape of the fine machining tool is symmetrical with respect to a central plane of the fine machining tool. In the second variant, the different tilt angles at the two ends of the tool take account of the fact that, on the side directed towards the tool holder, i.e. that side with which the tool is clamped in the tool holder of the gear cutting machine, there is an interfering contour by the tool arbor which can stand in the way of machining with a large tilt angle. Optionally, a non-symmetrical barrel shape is selected in order to make possible the different tilt angles.

Optionally, the difference between the tilt angles is at least 5% of the smaller value in terms of absolute value, optionally at least 10%.

According to a possible embodiment of the present disclosure, gear machining, in which the fine machining tool, as described above, is moved, in at least one toothing cut, in a feed direction parallel to the axis of rotation of the workpiece through the workpiece, is used for a roughing machining, while the finishing machining is carried out by honing. The method described above would then only be used for roughing. The finishing, by contrast, can be carried out by a honing machining. This can be carried out according to a known procedure. For example, the honing tool is introduced radially into the workpiece. In the axial direction of the workpiece and/or tool, an oscillating movement can be carried out here.

According to a possible embodiment of the present disclosure, the first gear machining and the honing are carried out with the same clamping of the workpiece and/or of the fine machining tool.

According to a possible embodiment of the present disclosure, a first region and/or part of the fine machining tool is used for the first gear machining and a second region and/or part of the fine machining tool is used for honing.

According to a possible embodiment of the present disclosure, the width crowning of the second region and/or part used for honing is smaller than the width crowning of the first region and/or part.

According to a possible embodiment of the present disclosure, a plurality of identical workpieces are gear-machined and/or a plurality of workpieces are provided, by the gear machining, with an identical geometry.

According to a possible embodiment of the present disclosure, the contact path is shifted several times in this case.

The present disclosure further comprises a fine machining tool for a method as described above, e.g. a toothed tool with a barrel-shaped basic form and with undefined cutting edge which is designed for a method according to the disclosure.

Within the scope of the present disclosure, the barrel-shaped basic form means in particular that the radius of the basic body defined by the fine machining tool, starting from a point with the largest radius, decreases on both sides in the direction of the axis of rotation of the fine machining tool and thus in the tool width direction. Optionally, the radius decreases continuously in this case. In particular, in this case the tool can be embodied as having width crowning.

The fine machining tool has a toothing, the teeth of which extend in the width direction on the circumferential surface of the fine machining tool. The toothing can be a straight toothing or a helical toothing.

According to a possible embodiment of the present disclosure, the fine machining tool has a first and a second width region, region and/or part with different abrasive material and/or a different width and/or a different width crowning. In particular, the fine machining tool and/or the regions are in this case embodied as already described above with regard to the method.

According to a possible embodiment of the present disclosure, the fine machining tool is in this case designed as a gear skiving tool with undefined cutting edge.

According to a possible embodiment of the present disclosure, the profile of the tool, for each tooth at every width position, in a sectional plane through a point at the outside diameter, has the form of a cutting edge of a gear skiving tool. In some examples, the profile is designed such that the gear skiving tool defining the profile is designed for the corresponding outside diameter and positioned at the selected effective axis crossing angle and can be tilted by a tilt angle δ which corresponds exactly to the derivative of the outside diameter profile at the corresponding width position.

The sectional plane in which the profile is defined corresponds in this case to the plane spanned by the cutting edge of the gear skiving tool defining the profile or by the rake face. Its orientation therefore depends on the rake angle and stagger angle selected for the corresponding gear skiving tool.

The rake angle and stagger angle can in this case be designed according to different strategies.

In one possible embodiment, a stagger angle is selected which lies in the range of +/-3° about the helix angle of the tool at the corresponding tool width and/or a rake angle which lies in a range of +/-3° about the tilt angle at the corresponding tool width, such that the profile on the fine machining tool is defined essentially in the normal section of the toothing thereof.

However, other stagger angles and/or rake angles are also conceivable.

In one possible embodiment, a stagger angle of 0° and a rake angle of 0° are selected such that the profile on the fine machining tool is defined in a face section.

However, no defined cutting edge is present on the fine machining tool; rather, the surface geometry is defined by the juxtaposition of such theoretical cutting edges in the tool width direction as a coherent surface with undefined cutting edge. This surface is formed on the tool by the envelope of the grains on the surface of the tool.

The present disclosure further comprises a gear cutting machine with a workpiece holder which is driven to rotate about a first axis of rotation and a tool holder which is driven to rotate about a second axis of rotation, wherein the tool holder and the workpiece holder are movable relative to one another via movement axes of the gear cutting machine, and with a control which is programmed to actuate the movement axes of the gear cutting machine such that the gear cutting machine carries out a method according to the disclosure as described above. Optionally, in this case the gear cutting machine carries out the method automatically.

Furthermore, the present disclosure comprises a computer program which comprises commands which, when they run on the control of a gear cutting machine as described above, actuate the movement axes of the gear cutting machine such that the gear cutting machine carries out a method according to the disclosure as described above.

The control has for example a microcontroller and a non-volatile memory on which the computer program is stored, the commands of the computer program being processed on the microcontroller. The control is connected to the drives of the movement axes of the gear cutting machine and actuates these.

The drives of the gear cutting machine are optionally NC drives.

The present disclosure will now be described in more detail with reference to exemplary embodiments and drawings.

### BRIEF DESCRIPTION OF THE FIGURES

The drawings show in:

FIG. 1A: a schematic representation of a method according to the disclosure and of a gear cutting machine according to the disclosure,

FIG. 1B: a perspective view of an exemplary embodiment of a gear cutting machine according to the disclosure,

FIG. 2: machining with a first and a second contact path within the scope of an exemplary embodiment of a method according to the disclosure,

FIG. 3: a schematic representation of two fine machining tools according to the disclosure on each of which a contact region belonging to the contact path is drawn in,

FIG. 4: a schematic representation of a fine machining tool according to the disclosure with a first and second width region with different abrasive material, and

FIG. 5: a schematic representation of a fine machining tool according to the disclosure with a symmetrical barrel shape and of a fine machining tool according to the disclosure with an asymmetrical barrel shape and thus two regions with different width,

FIG. 6A and FIG. 6B: the course of the cutting edges of the theoretical gear skiving tools via which the surface geometry of the fine machining tool is defined, in two exemplary embodiments, for different tool width positions, FIG. 6A showing the case in which the stagger angle and the rake angle are zero and FIG. 6B showing the case in which the stagger angle corresponds to the helix angle, and

FIG. 7: the course of the cutting edges of the theoretical gear skiving tools via which the surface geometry of the fine machining tool is defined, with a rake angle of the theoretical cutting edges adapted to the tilt angle.

### DETAILED DESCRIPTION

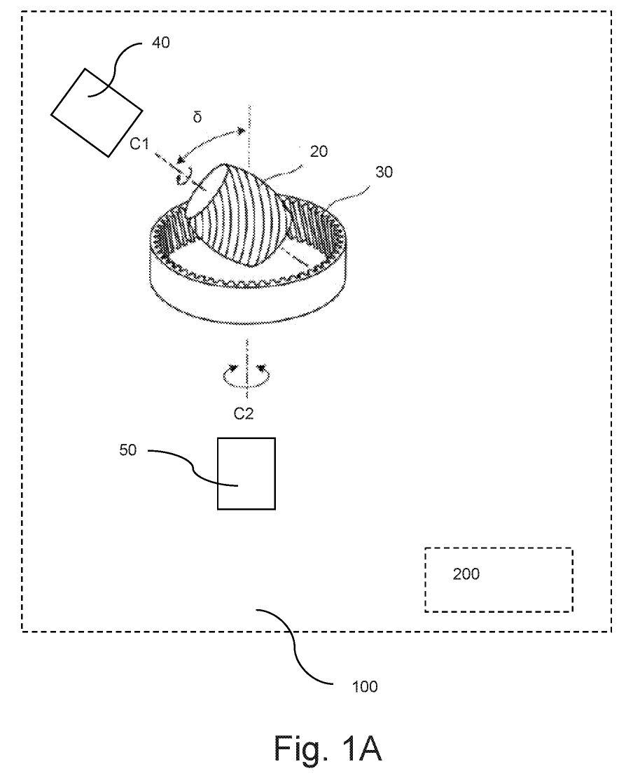

FIG. 1A shows a gear cutting machine 100 according to the disclosure in a schematic representation.

The gear cutting machine 100 has a workpiece holder 50 which is driven to rotate about a first axis of rotation C2 and a tool holder 40 which is driven to rotate about a second axis of rotation C1. The tool holder 40 can in particular be embodied as a tool holder in which the tool is clamped at one end. The tool holder 40 and the workpiece holder 50 are movable relative to one another via movement axes of the gear cutting machine. The axis arrangement optoinally corresponds in this case to that of a gear skiving machine and/or a honing machine.

FIG. 1B shows an exemplary embodiment of a gear cutting machine and the movement axes available on the gear cutting machine.

In particular, a movement axis Z1 is provided, by which the tool holder 40 can be moved relative to the workpiece holder 50 such that the tool 20 can be moved, in the direction of the axis of rotation C2 of the workpiece holder, through the workpiece. For this purpose, the movement axis Z1 optionally runs parallel to the axis of rotation C2. Furthermore, a movement axis X1 can be provided via which the infeed of the tool 20 into the workpiece 30 takes place. The movement axis X1 optionally stands perpendicularly on the axis of rotation C2. The movement axis V1 can permit a movement in a plane perpendicular to the X1-axis and/or in a direction perpendicular to the axis of rotation C1. The movement axes X1, V1 and Z1 may be linear axes.

Furthermore, a pivot axis A1 is provided which runs parallel to the X1-axis and perpendicular to the C1-axis and via which the tool holder 40 can be rotated.

Depending on the embodiment, in this case the A1-axis can rotate a machining head which comprises the V1-axis and the tool holder 40, or the A1-axis can be arranged on a slide which can be moved via the V1-axis and rotates only the tool holder 40. In the latter case, the V1-axis stands perpendicularly on the Z1-axis; in the former case, the V1-axis can be rotated, via the A1-axis, in a plane which stands perpendicularly on the X1-axis and optionally stands perpendicularly on the C1-axis, i.e. it can displace the C1-axis in parallel.

Via the A1-axis, in interaction with the X1-axis and the V1-axis, the tilt angle and the axis crossing angle between the axes C2 and C1 can be set.

If the tool is positioned laterally beside or inside the workpiece such that the axes of rotation C2 and C1 of workpiece and tool lie in a plane which stands perpendicularly on the A1-axis, the tilt angle can be set by pivoting the A1-axis.

If, by contrast, the tool is located in front of or in the workpiece such that the common perpendicular of the axes of rotation C2 and C1 of workpiece and tool runs parallel to the A1-axis, pivoting of the A1-axis changes the axis crossing angle.

In an intermediate position, both the axis crossing angle and the tilt angle are changed by changing the A1-axis. The structural embodiment of the movement axes is, however, not restricted to the embodiment described above. The present disclosure can also be carried out with other embodiments of the movement axes.

Furthermore, a control 200 is provided which is programmed to carry out a method according to the disclosure. The movement axes optionally have NC drives which are actuated by the control.

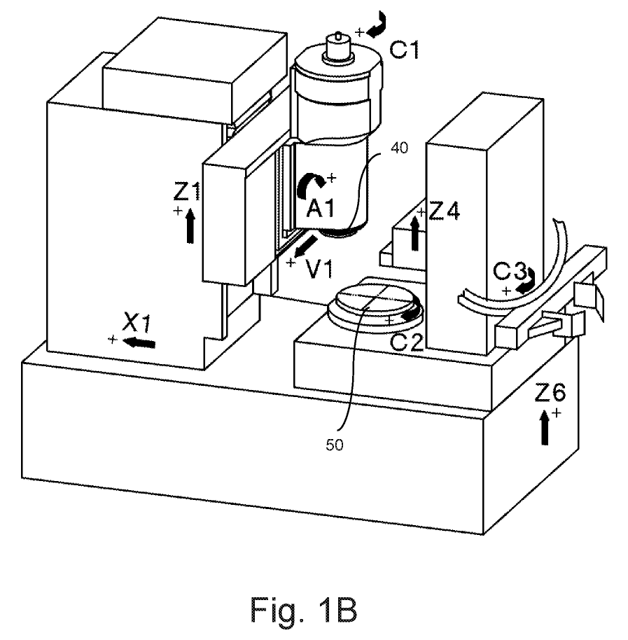

The idea of the method according to the disclosure shown in FIG. 2 now consists in designing the tool 20 such that the contact path 24, 24' between tool 1 and workpiece 2 can be shifted. This is realized, as shown in FIG. 2, by a change of the tilt angle of the barrel-shaped or width-crowned tool 20 with geometrically undefined cutting edge.

Since machining is usually carried out off-center, several axes in combination are used for this purpose in practice. Furthermore, the center distance and the axis crossing angle are tracked.

For example, in this case the A1-axis is used to pivot the tool 20, while the position of the further axes Y1, X1, C1, Z1, C2 is adapted such that the tool is still in engagement with the workpiece, the desired tilt angle and axis crossing angle result, and, with the new contact path, the same geometry is produced on the workpiece as with the old contact path.

By shifting the contact path 24 to 24', after reaching the tool life path end of the first contact path 24, a new, hitherto unused contact path 24' can be brought into engagement with the workpieces.

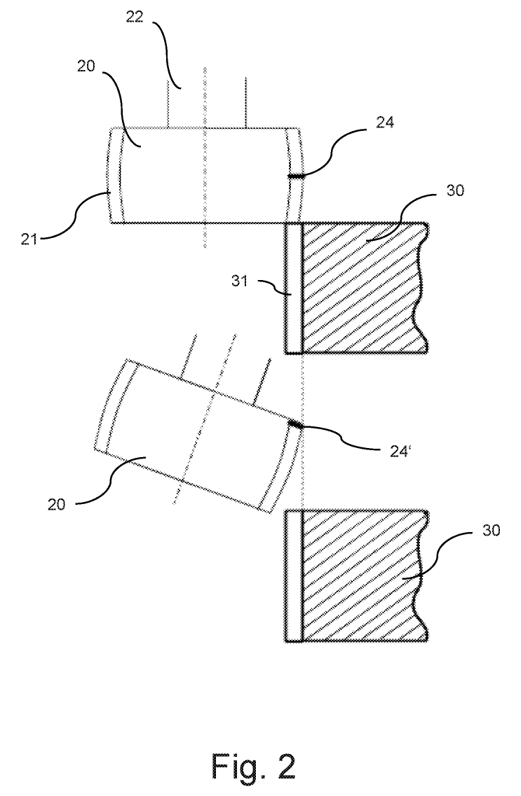

The already used contact path 24 is shifted into the contact surface 23, 23' which is not decisive with regard to quality for material removal, which is shown in FIG. 3. The process of bringing hitherto unused contact paths 23' into engagement can be repeated multiple times until the upper edge of the tool 20, 20' is reached.

FIG. 2 shows the shifting of the contact path 24 from the high point of the crowning to the last possible shifting position of the contact path 24' at the upper edge of the tool. On the way from contact path 24 to contact path 24', further shift positions of the contact path are optionally used.

The machining process optionally corresponds in kinematic terms to gear skiving, but is carried out with a fine machining tool with undefined cutting edge. It is therefore optionally a gear skiving machining with undefined cutting edge. In particular, a significantly smaller axis crossing angle is used here than, for example, in generating grinding.

In order to determine the required geometry of the tool, a maximum outside diameter on the tool is first fixed according to a possible embodiment of the present disclosure, as well as an axis crossing angle under which the tool is to operate. In this case, the axis crossing angle denotes the angle of the crossed axes of rotation of workpiece and tool when projected along their common perpendicular, which also corresponds to the effective axis crossing angle when machining the toothing with the contact trace on the tool at the height of the maximum outside diameter.

From this axis arrangement, by a cylindrical section of the workpiece root circle cylinder with a plane which is given by the axis of rotation of the tool and the common perpendicular vector as spanning vectors, an ellipse results whose short semi-axis corresponds to the selected maximum outside diameter on the tool. This ellipse gives a limitation of the outside diameter on the tool over its width, i.e. the position in the direction of the axis of rotation of the tool, which, starting from the maximum diameter, must be undershot in both directions strictly monotonically decreasing with a monotonous derivative in order to obtain clearance for shifting – which can be implemented in practice, for example, by a parabola as a modification of the cylindrical section.

Subsequently, for each width position on the tool, a cutting edge of a skiving tool can be designed (for example with publicly available software such as SkiveAll^{TM}) such that the gear skiving tool is designed for the corresponding outside diameter and positioned at the selected effective axis crossing angle and is tilted by a tilt angle δ which corresponds exactly to the derivative of the outside diameter profile at the corresponding height, such that the tooth head of the tool can lie tangentially in the root of the workpiece to be produced.

These cutting edges are then combined to form a tool such that, at the diameter of the tool which produces a random but fixed diameter of the workpiece, the helix angle at each width position of the tool corresponds to the difference between effective axis crossing angle and helix angle of the workpiece.

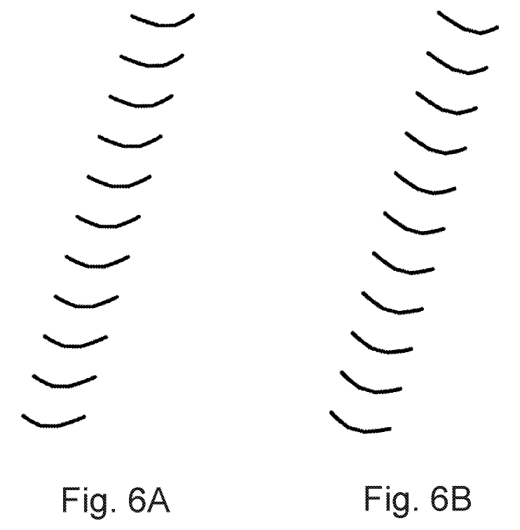

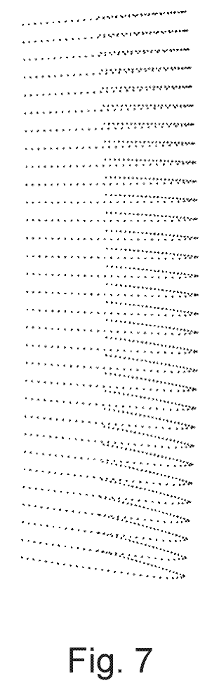

FIGS. 6 and 7 show the cutting edges selected to define the tool for one tooth of the tool as a function of their position in tool width, which here runs from top to bottom.

For each position in tool width, a theoretical gear skiving tool with the maximum outside diameter present there according to the selected outside diameter profile is defined, whose cutting edge then defines the surface of the tool at this width position.

The orientation of the cutting edges via which the geometry of the tool is defined can in this case be selected in the same way as for a normal gear skiving tool with defined cutting edge by selecting the stagger angle and rake angle.

With a stagger angle and rake angle of zero, the geometry of the tool is defined for all teeth in a plane which stands perpendicularly on the axis of rotation of the tool, as shown in FIG. 6A for one tooth of the toothing.

With a stagger and/or rake angle unequal to zero, by contrast, the geometry of the tool is defined for each tooth in a plane assigned to this tooth at the corresponding tool width. In this case, the plane in which the cutting edge of the theoretical gear skiving tool is located and in which thus the profile of the tooth is defined, for each tooth can be rotated about an axis which runs from the tooth head to the axis of rotation of the tool, which corresponds to a stagger angle of the cutting edge, and, at the same time, this axis can be inclined with respect to a plane which stands perpendicularly on the axis of rotation, which corresponds to a rake angle of the cutting edge.

In particular, in the case of gear skiving tools it is customary to select a stagger angle which essentially corresponds to the helix angle of the tool, such that the cutting edge runs in a plane which runs perpendicularly to the extent of the tooth and thus perpendicularly on the surface of the tooth flanks, as shown in FIG. 6B.

The stagger angle can in this case be kept constant over the tool width. The rake angle, which is defined with respect to the axis of rotation of the tool and thus independently of the positioning relative to the workpiece, can, by contrast, be tracked with the tilt angle, as shown in FIG. 7, in order thereby to have the same engagement conditions on the workpiece along the plane in which the profile is defined independently of the tilt angle.

Investigations have revealed, however, that the surface geometry of the tool resulting from the definition according to the disclosure is largely independent of the planes in which the profile is defined and thus largely independent of stagger angle and rake angle.

The strictly monotonic course of the outside diameter can be selected such that an intended infeed on a width region to be defined is achieved as a deviation from the enveloping ellipse, whereby the tool then removes material, in one cut, with the intended infeed on the defined width region. In practice, this will rather be defined on the flank, whereby the intended infeed is calculated, via the profile angle, from flank stock to be removed, such that the stock to be removed is then taken off on the defined width region. In this way, by selecting the outside diameter course, the width region on the tool which removes material can be selected – by a stronger deviation from the ellipse, a smaller region – and this can in particular be selected differently at different width positions of the tool.

Typically, not the complete toothing is finely machined, but only the active flanks or the involute part within the form circles, such that, in the soft machining, a relief cut is introduced by a tool with protuberance, such that a machining allowance remains on the flank. For designing the tool, a toothing corrected by a tip and root clearance instead of the desired final geometry is then used.

The axis crossing angles used within the scope of the method according to the disclosure can lie, for example, in a range between 0 degrees and ± the helix angle of the workpiece and/or in a range between 0 degrees and ± 30°, for example in a range between 0 degrees and ± 25°.

The tilt angle is changed, within the scope of the present disclosure, in order to bring new contact paths into engagement with the workpiece. In this case, the tilt angle can be varied in an angular range which usually extends from a maximum of -30° to a maximum of +30°, but typically only from a maximum of -15° to a maximum of +15°.

Optionally, the overall change of the tilt angle of the tool within the scope of the method according to the disclosure amounts to more than 1°, optionally more than 4°, in possible applications also more than 10° or more than 20°. The change of the tilt angle usually takes place in a plurality of steps, with each of which the contact path is shifted in order to machine one or more workpieces with the new contact path.

In this case, the axis crossing angle is tracked to the tilt angle in order to keep the engagement conditions essentially the same or to set the effective axis crossing angle to a desired value.

The change of the axis crossing angle in this case corresponds in magnitude order to that of the tilt angle.

The effective axis crossing angle can, by contrast, remain the same for the entire machining. However, this leads, in terms of tool design, to the fact that, in the case of a tool which is actually straight-toothed, the position of the tooth flanks changes slightly over the tool width.

In one possible embodiment of the present disclosure, the effective axis crossing angle can therefore also be changed over the tool width in order to compensate for this effect. In one possible embodiment, the change of the effective axis crossing angle, however, amounts to less than +/-1 degree.

The tracking of the axis crossing angle over the tool width therefore serves, on the one hand, to adapt to the changed tilt angle and, if appropriate, to set the changed effective axis crossing angle.

Shifting of the contact path 24, 24' can take place both between individual cuts and also during a cut. A cut is the axial traversing of the toothing of the workpiece 20 with the tool 30.

By differently strongly crowned modified tools 20, 20', as shown in FIG. 3, the contact area 23, 23' between tool 20, 20' and workpiece 30 can be enlarged or reduced. In this way, the material removal can be distributed over a corresponding surface. In particular, in this case the tool shown on the right has a greater crowning than the tool shown on the left, such that, with the same infeed to the workpiece or the same material removal, a smaller contact area 23' results.

In this case, the crowning and the material removal which is carried out by a machining cut can be set such that the width of the contact area 23, 23' is greater than 5%, optionally greater than 10% of the total width of the tool. Considerably greater widths are also conceivable. Thus, the width of the contact area can be greater than 20%, 30%, 40% or 50% of the total width of the tool. Optionally, the width is less than 70% of the total width of the tool. That region which is not taken up by the contact area can then, according to the disclosure, be used to shift the contact path 4, 24'. This contact path 24, 24' constitutes the rear delimiting line of the contact area in the feed direction.

By tilting the tool 20, 20', the contact surface 23, 23' and thus the contact path 24 , 24' can also be shifted.

As already described above, the contact path 24, 24' constitutes the upper delimitation of the contact surface 23, 23' if the tool 20, 20' is moved from top to bottom through the workpiece and not vice versa. This permits machining with a single cut in the ideal case, in which the main material removal (roughing) is carried out by the surface 23, 23' and the contact path 24, 24' produces the final geometry of the workpiece (finishing).

In this case, the contact path can be shifted into a hitherto unused region as soon as the region currently used is worn.

However, a multiplicity of other shift strategies, i.e. strategies as to how this shifting of the contact path is used in order to optimally utilize the tool width, also result. For example, in this case machining can also be carried out in at least two separate cuts, i.e. at least one roughing cut and one finishing cut.

In particular, the following variants are conceivable:

roughing / finishing in the new region. Subsequently, shifting such that the previous finishing region shifts into the roughing region.

roughing / finishing in separate regions with shifting between the cuts (if necessary pivoting in each case into a new region)

segment shifting

In addition to different shift strategies, it is likewise conceivable to use different abrasive materials and in particular coatings for a roughing and a finishing region, to use different embodiments of the tool (conditioned / non-conditioned) and/or to carry out roughing according to the disclosure by axial traversing through the workpiece and to carry out finishing radially by honing.

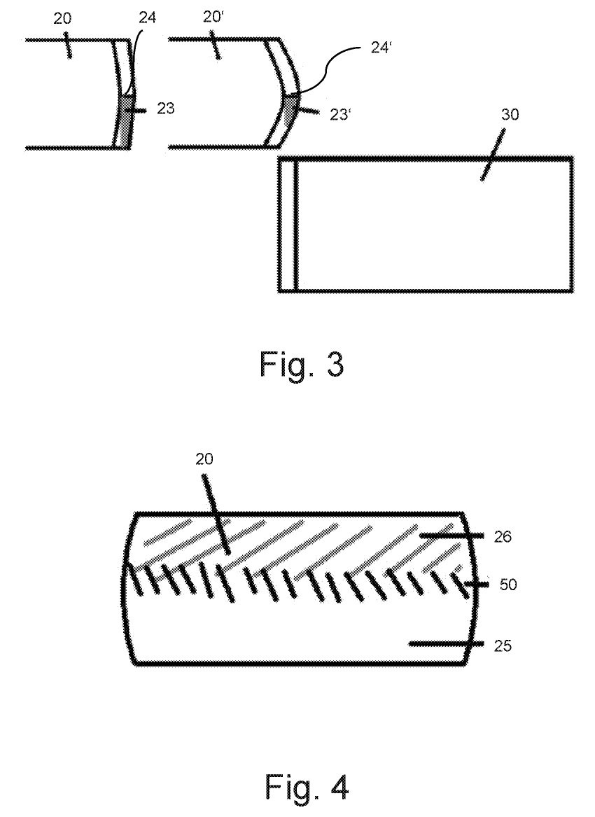

For this machining strategy, a tool with differently coated regions can be used in particular, as shown in FIG. 4, such that, for example, the region 25 lying at the front in the feed direction is coated with coarser grain and is used for roughing, while the part 6 lying at the rear in the feed direction is coated with fine grain.

Thus, in a central region 50, in a single cut, roughing can be carried out with fine grain and finishing with coarse grain, or each region can, by tilting as described above, be approached on different contact paths and thus be uniformly worn. This division can be produced in one tool or the tool can be assembled as a tandem tool.

According to the disclosure, the tool can also be used with homogeneous coating in order then either to rough and finish with different tools, or to carry out, by an adapted cutting strategy, first a rough machining and then a further finishing of the surface by smaller infeed, reduced feed or machining which is opposite in direction to the rough machining.

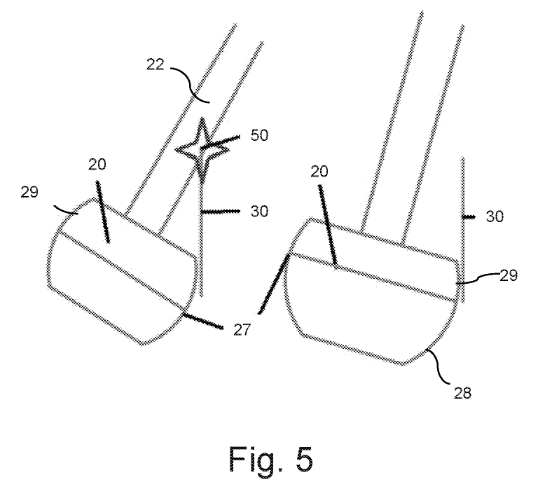

Since always the region in the machining direction in front of the contact path 24 removes material but does not contribute to the final geometry, a contact trace arises which is located furthest forward in the feed direction, under which the contact paths on the corresponding tool width can never be approached. At the rear end, however, shifting can theoretically be carried out up to the end of the tool, such that, in the case of a symmetrical embodiment of the tool over the width, steeper tilt angles arise here, as shown in FIG. 5 on the left. In the usual machining direction adopted from skiving, this is the side on which the tool arbor 22 extends for the tool and on which the tool is clamped in the tool holder, which, as shown in FIG. 5 on the left, is unfavorable for collision reasons 50.

This problem can be approached in two ways:

1. The barrel shape or width crowning on the tool is applied asymmetrically over the tool width, as shown in FIG. 5 on the right, such that the high point 27 on the toothing sits, with respect to the center, in the feed direction towards the rear and/or closer to the tool holder on the tool, in order thus to shift the tilt angles for the positions which can be approached away from the workpiece. As a result, the region 28 in which the radius decreases, starting from the high point 27, in the feed direction and/or away from the tool holder, has a greater width than the region 29 in which the radius of the tool decreases, starting from the high point 27, counter to the feed direction and/or towards the tool holder. This can be carried out such that the tilt angles for the positions which can be approached are symmetrical, or even further, as shown on the right in FIG. 5. This can make sense mainly for collision reasons, but can also be used for other objectives.

2. The process is carried out in a pulling manner, whereby the region directed towards the tool holder 29 becomes the region which cannot be approached for the final contour, whereby the unfavorable tilt angles are eliminated. Here also, in addition, the tool can be embodied asymmetrically over the width in the same style as under point 1. The pulling machining, in the case of crowning over the width which is symmetrical, in particular reduces the overrun path, since the contact path which is to be approached at the highest point on the tool thus sits further away from the end of the tool pointing to the tool holder. This can be used, among other things, to reduce the clamping width or, in the case of toothings which are critical with regard to overrun, to have a further possibility in tool design to reduce the overrun. This possibility in this case exists in addition to the options known from skiving: reduction of tilt angle, reduction of outside diameter, both of which have disadvantages, whereas, in pulling machining, no disadvantages occur at first. In pulling machining, the feed of the tool through the workpiece is such that the tool holder is arranged in front of the tool in the feed direction; in pushing machining, by contrast, it is arranged behind the tool.

The method according to the disclosure can be used for example for gear machining of internal toothings and makes it possible, in comparison with known methods, to considerably better utilize the tool and thereby reduce costs.

The method according to the disclosure can also be used in exactly the same way for external toothings. Although other effective methods are already available in many cases here, the method according to the disclosure can be advantageous in particular when, on account of limited overrun or toothings which are critical with regard to collision, methods such as, for example, generating grinding cannot be used. In this case, the method according to the disclosure has essentially the same fields of application as gear skiving with a tool with defined cutting edge.

The method according to the disclosure can be used for complete hard fine machining of the workpieces on one machine. It is likewise conceivable to use the method for super-finishing or polishing. The embodiment of the tool in this case is, in terms of material, as in the case of a finishing tool or polishing tool. For example, in this case the tool can consist of a flexible material or be coated with such a material.

1. A method for gear machining of one or more workpieces by means of a toothed fine machining tool with undefined cutting edge, which has a barrel-shaped basic form,
wherein the fine machining tool and the workpiece rotate rollingly coupled with one another while the fine machining tool, in at least one toothing cut, is moved in a feed direction parallel to the axis of rotation of the workpiece in order to machine the workpiece over the workpiece width,
wherein, between the machining of two workpieces and/or between two toothing cuts on one workpiece and/or during a toothing cut, the contact path between fine machining tool and workpiece is deliberately shifted on the fine machining tool in order to bring another region of the tool surface into use, by changing the tilt angle between the fine machining tool and the workpiece.

2. The method according to claim 1, wherein the relative movement of workpiece and fine machining tool takes place with the kinematics of gear skiving machining and/or wherein the fine machining tool is a gear skiving tool with undefined cutting edge, and/or wherein the fine machining tool is a non-dressable tool, or wherein the contact path between fine machining tool and workpiece on the fine machining tool is shifted without dressing the fine machining tool in the meantime.

3. The method according to claim 1, wherein the contact path between the fine machining tool and the workpiece on the fine machining tool is shifted after a predetermined number of toothing cuts and/or a predetermined shift strategy and/or wherein the change of the tilt angle takes place without or independently of a measurement of an actually produced geometry of the workpiece.

4. The method according to claim 1, wherein the contact path is shifted several times into another region of the tool surface by a change of the tilt angle, and/or wherein the contact path is shifted in one or more steps by a total of at least 10% of the tool width.

5. The method according to claim 1, wherein the material removal on the workpiece in one machining cut takes place within a contact region with the fine machining tool which, on the fine machining tool, has an extent in the feed direction, wherein the contact path is formed by the end of the contact region which lies at the rear in the feed direction.

6. The method according to claim 1, wherein the barrel shape of the fine machining tool and/or the form of the teeth and the infeed to the workpiece are selected such that the width of a contact region between the workpiece and the fine machining tool, in which material removal on the workpiece takes place in one machining cut, amounts to at least 10% of the tool width.

7. The method according to claim 1, wherein the fine machining tool is clamped on a tool arbor which is mounted at one end in a tool holder.

8. The method according to claim 1, wherein the fine machining tool has two width regions with different abrasive material.

9. The method according to claim 8, wherein, by tilting the fine machining tool between a roughing machining and a finishing machining, a first width region is used for roughing and a second width region is used for finishing and/or wherein the contact region during grinding is selected such that a front part of the contact region in the feed direction lies in a first width region with a first grain size and the contact path lies in a second width region with a second grain size, the first grain size being coarser than the second grain size.

10. The method according to claim 1, wherein a point of the fine machining tool having the largest radius is arranged offset with respect to the middle of the tool width and divides the tool into a first and a second region with decreasing radius starting from this point, which have different widths.

11. The method according to claim 1, wherein gear machining, in which the fine machining tool is moved, in at least one toothing cut, in a feed direction parallel to the axis of rotation of the workpiece, is used for a roughing machining, while the finishing machining is carried out by honing.

12. The method according to claim 1, wherein a plurality of identical workpieces are gear-machined and/or a plurality of workpieces are provided, by the gear machining, with an identical geometry.

13. A fine machining tool for performing the method according to claim 1, comprising a first and second width region with different abrasive materials and/or a different width and/or a different width crowning, and/or wherein the fine machining tool is a gear skiving tool with undefined cutting edge whose profile, for each tooth at each width position, in a sectional plane through a point at the outside diameter, has the form of a cutting edge of a gear skiving tool.

14. A gear cutting machine with a workpiece holder which is driven to rotate about a first axis of rotation and a tool holder which is driven to rotate about a second axis of rotation, wherein the tool holder and the workpiece holder are movable relative to one another via movement axes of the gear cutting machine, and with a control which is programmed to actuate the movement axes of the gear cutting machine such that the gear cutting machine carries out the method according to claim 1.

15. A computer program with commands which, when run on a control unit of a gear cutting machine, actuate movement axes of the gear cutting machine such that the gear cutting machine carries out the method according to claim 1.

16. The method according to claim 2, wherein the non-dressable tool is a galvanically coated CBN tool.

17. The method according to claim 4, wherein the shifting in each case takes place such that the tool surface in the other region has not yet been worn, or has been worn to a lesser extent, than in the region in which the contact path ran before shifting.

18. The method according to claim 4, wherein the contact path is shifted in one or more steps by a total of at least 20% of the tool width.

19. The method according to claim 6, wherein the barrel shape of the fine machining tool and/or the form of the teeth and the infeed to the workpiece are selected such that the width of a contact region between the workpiece and the fine machining tool, in which material removal on the workpiece takes place in one machining cut, amounts to at least 20% of the tool width.

20. The method according to claim 7, wherein the feed movement of the machining cut takes place in a pulling manner.
